(19) United States
(12) Patent Application Publication
(10) Pub. No.: US 2021/0007372 A1
(43) Pub. Date: Jan. 14, 2021

(54) SOYBEAN BEVERAGE COMPOSITION

(71) Applicant: DAVID EOM, WOODSIDE, NY (US)

(72) Inventor: DAVID EOM, WOODSIDE, NY (US)

(21) Appl. No.: 16/504,379

(22) Filed: Jul. 8, 2019

(51) Int. Cl. A23L 2/02; A23L 2/52; A23L 33/105

(52) U.S. Cl. CPC A23L 2/02; A23L 33/105; A23L 2/52

(57) ABSTRACT

The present invention is a soybean beverage composition that includes a soybean processed food; water; at least one first juice selected from the group consisting of fruit juice; at least one second juice selected from the group consisting of vegetable juice; and a vinegar blend.

### TECHNICAL FIELD & BACKGROUND

The present invention relates generally to a soybean beverage composition, and in particular, to an improved soybean beverage composition.

Health-related beverages have become popular during the last decades. Often such beverages may contain various kinds of fruit and vegetable juices and blends. Some related examples of vegetables and fruits that can be consumed as a juice or juice blend are: (1) Carrots—Contain beta-carotene and other carotenes. Carrots also have a very strong antioxidant activity and may aid in immune system support. In addition, they may aid and support mucous membrane, skin and eye health. They also are a ready source of energy and may aid to reduce the risk of heart disease, as well as calm the bowel and slow down bacterial development. (2) Mango—Mango juice is an excellent natural source of vitamins, microelements and nutrients. This tropical fruit is very rich in potassium, one of the most important microelements for our cardiovascular health.

However, unlike such popular vegetable and fruit derived beverages, soybean derived beverages have not been popular due to the unpleasant odor and taste of soybeans. In fact, such unpleasant odor and taste is a factor preventing the widespread use of soybean derived beverages. After eating or drinking soybean food or drinks, we often feel irritated over the whole area of the mouth cavity and the throat. This irritating taste is similar to a slightly astringent taste. Such unpleasant taste is felt especially after drinking soybean milk and is caused by the reaction of a taste substance with a protein-like substance contained in soybean.

Therefore, it would be desirable to provide an improved soybean beverage composition that could eliminate such unpleasant odor and taste of soybeans.

### SUMMARY OF THE INVENTION

The present invention is an improved soybean beverage composition that overcomes the above-mentioned disadvantages of the prior art.

In one aspect, the present invention provides a soybean beverage composition comprised of soybean processed food, water, at least one first juice selected from the group consisting of fruit juice, at least one second juice selected from the group consisting of vegetable juice, and a vinegar blend.

In another aspect, the present invention provides a method of preparing a soybean beverage composition comprised of providing a soybean processed food, providing water, providing a vinegar blend, providing at least one first juice selected from the group consisting of fruit juice, providing at least one second juice selected from the group consisting of vegetable juice; and combining the soybean processed food, water, the at least one first juice, the at least one second juice; and the vinegar blend into a mixture.

In a further aspect, the present invention provides a method of preparing a soybean beverage composition comprised of grinding a soybean processed food, providing water, providing a vinegar blend, providing at least one first juice selected from the group consisting of fruit juice, providing at least one second juice selected from the group consisting of vegetable juice, and mixing the ground soybean processed food, water, the vinegar blend, the at least one first juice, and the at least one second juice to form a liquid mixture, and bottling the liquid mixture.

### BRIEF DESCRIPTION OF THE DRAWINGS

N/A

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

Throughout this disclosure, a juice shall be understood to mean a liquid that is naturally contained in or derived from fruit or vegetables.

Throughout this disclosure, a juice blend shall be understood to mean a mixture of one or more individual juices. As an example, pure orange juice is a juice blend, and a mixture of orange juice, apple juice, and tomato juice is a juice blend.

Throughout this disclosure, a raw juice shall be understood to mean a juice, which has not undergone any heating, pasteurization, concentration, distillation, or other processing, other than extracting the raw juice from a juice source, such as a vegetable, a fruit or other biological food item that contains a liquid.

Soybeans contain antioxidants and phytonutrients that are linked to various health benefits. Various soy products are available, including soybean flour, soybean protein, soybean tofu, soybean milk, soybean sauce, soybean oil, black bean flour, black bean protein, black bean tofu, black bean milk, black bean sauce, and black bean oil. Soybeans are mainly composed of protein but also contain good amounts of carbohydrates and fat. The main types of protein in soybeans are glycinin and conglycinin, which make up approximately 80% of the total protein content. Consumption of soy protein has been linked with a modest decrease in cholesterol levels. Soybeans are a good source of various vitamins and minerals. Further, vinegar also has historically been recognized as having a number of health benefits. Limited trials in rodents have indicated lowering of cholesterol and blood pressure. Prior to the discovery of modern hypoglycemic agents, diabetics used vinegar teas to control symptoms. A number of medical studies have shown reduction of the glycemic index for carbohydrate foods. Vinegar was thought to be useful for treating infections in historic times. It is known that the active ingredient in vinegar, acetic acid is effective against mycobacteria, including drug-resistant strains.

In the present invention, it has been discovered that a mixture of soybean processed food and vinegar blend in a single composition not only yields such health benefits but also helps to eliminate the unpleasant odor and unpleasant taste of soybean.

In an embodiment, a soybean beverage composition can comprise a soybean processed food; water; at least one fruit juice selected from the group consisting of fruit juice; at least one vegetable juice selected from the group consisting of vegetable juice; and a vinegar blend. The soybean processed food can comprise soybean flour, soybean protein, soybean tofu, soybean milk, soybean sauce, soybean oil, black bean flour, black bean protein, black bean tofu, black bean milk, black bean sauce and black bean oil. The water can be filtered water. The vinegar blend can comprise substantially equal parts of fruit derived vinegar and sugar (or honey), most preferably pineapple vinegar and sugar. The vinegar blend can comprise pineapple vinegar, apple vinegar, lemon vinegar, orange vinegar, grape vinegar, blueberry vinegar, raspberry vinegar, kiwi vinegar, strawberry vinegar, cranberry vinegar, cherry vinegar, and prune vinegar. The efficacy of this mixture of the soybean processed food and vinegar blend is enhanced through the addition of selected juice, which is believed to synergistically react with the soybean processed food and vinegar blend. In a preferred embodiment of the invention, the mixture of the soybean processed food and vinegar blend is complemented by the addition of one or more natural fruit, natural vegetable, vegetable juice and fruit juice selected from the group consisting of apple, banana, tomato, carrot, blueberry, cherry, cantaloupe, grape, grapefruit, cranberry, celery, kiwi, papaya, parsley, pear, pineapple, prune, raspberry, berry, orange, lemon, cucumber, green barley, strawberry, spinach, lettuce, green lettuce, cabbage, kale, and celery. In related aspects, vinegar acts as a natural preservative. When combined with raw fruit and vegetable juices, the vinegar kills unhealthy bacteria. A proper amount of vinegar will produce probiotics. In aspects of this invention, fruit beverages with compositions of vinegar are enhanced with components, such as vitamins, minerals enzymes, phytonutrients, and probiotics that may provide a range of health benefits, including improving the health of the digestive system.

In a related embodiment, the overall percentage of the volume for the vinegar blend is between 4 and 7% of the total weight of the soybean beverage composition. The overall percentage of the volume for the soybean processed food is between 4 and 10% and most preferably between 5% and 6% of the total weight of the soybean beverage composition. The overall percentage of the volume for water is between 50 and 60% and most preferably between 55 and 58% of the total weight of the soybean beverage composition. The overall percentage of the volume for the fruit juice is between 15 and 20% of the total weight of the soybean beverage composition. The overall percentage of the volume for the vegetable juice is between 15 and 20% of the total weight of the soybean beverage composition.

In a related embodiment, a kale-based soybean beverage composition, can comprise in total percentages by weight:

a. A juice blend, further comprising:

| | |
|---|---|
| i. Kale | 15% |
| ii. Banana | 8% |
| iii. Apple | 8% |

b. A vinegar blend, further comprising:

| | |
|---|---|
| i. Pineapple Vinegar | 6% |

c. A soybean processed food, further comprising:

| | |
|---|---|
| i. Soybean flour | 5% |
| ii. Water | 58% |

In a further related embodiment of the kale based soybean beverage composition, the water can be filtered water.

In a related embodiment, a carrot-based soybean beverage composition, can comprise in total percentages by weight:

a. A juice blend, further comprising:

| | |
|---|---|
| i. Carrot | 17% |
| ii. Banana | 8% |
| iii. Apple | 8% |

b. A vinegar blend, further comprising:

| | |
|---|---|
| i. Pineapple Vinegar | 4% |

c. A soybean processed food, further comprising:

| | |
|---|---|
| i. Soybean flour | 5% |
| ii. Water | 58% |

In a related embodiment a blue berry-based soybean beverage composition, can comprise in total percentages by weight:

a. A juice blend, further comprising:

| | |
|---|---|
| i. Blue berry | 17% |
| ii. Banana | 8% |
| iii. Apple | 8% |

b. A vinegar blend, further comprising:

| | |
|---|---|
| i. Pineapple Vinegar | 4% |

c. A soybean processed food, further comprising:

| | |
|---|---|
| i. Soybean flour | 5% |
| ii. Water | 58% |

In a related embodiment, a tomato-based soybean beverage composition, can comprise in total percentages by weight:

a. A juice blend, further comprising:

| | |
|---|---|
| i. Tomato | 17% |
| ii. Banana | 8% |
| iii. Apple | 8% |

b. A vinegar blend, further comprising:

| | |
|---|---|
| i. Pineapple Vinegar | 4% |

c. A soybean processed food, further comprising:

| | |
|---|---|
| i. Soybean flour | 5% |
| ii. Water | 58% |

In a related embodiment, a cucumber-based soybean beverage composition, can comprise in total percentages by weight:

a. A juice blend, further comprising:

| | |
|---|---|
| i. Cucumber | 17% |
| ii. Lemon | 8% |
| iii. Apple | 8% |

b. A vinegar blend, further comprising:

| | |
|---|---|
| i. Pineapple Vinegar | 4% |

c. A soybean processed food, further comprising:

| | |
|---|---|
| i. Soybean flour | 5% |
| ii. Water | 58% |

The present invention can be produced through large-scale, economical operations. The soybean processed food can be ground into a mixture using commercial grinding or mixing equipment. The resulting mixture of the soybean processed food can then be further processed through the addition of the vinegar blend and one or more of the selected fruits and vegetable juice listed above. In preferred embodiments of the beverage form of the invention, the vinegar blend and the selected fruit and vegetable juice are then added to the mixture in accordance with the amounts, ranges, and ratios specified above. The liquid soybean beverage composition can then be treated, bottled or packaged for distribution to consumers using a variety of methods known to those of ordinary skill in the art, such as pasteurization, flash pasteurization, sterilization, UHT sterilization, pressure sealing, freezing, freeze drying, irradiating, etc. Dehydrated and other forms of the soybean beverage composition can also be prepared using standard techniques.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A soybean beverage composition, comprising:
a soybean processed food;
water;
at least one first juice selected from the group consisting of fruit juice;
at least one second juice selected from the group consisting of vegetable juice; and
a vinegar blend.

2. The soybean beverage composition according to claim 1, wherein the at least one first juice comprises fruit juice.

3. The soybean beverage composition according to claim 2, wherein the fruit juice is comprised of at least one of apple juice, banana juice, blueberry juice, cantaloupe juice, cherry juice, cranberry juice, grape juice, grapefruit juice, kiwi fruit juice, orange juice, pear juice, pineapple juice, prune juice, berry juice, raspberry juice and strawberry juice.

4. The soybean beverage composition according to claim 1, wherein the at least one second juice comprises vegetable juice.

5. The soybean beverage composition according to claim 4, wherein the vegetable juice is comprised of at least one of carrot juice, celery juice, green barley juice, green lettuce juice, kale juice, parsley juice, spinach juice and tomato juice.

6. The soybean beverage composition according to claim 1, wherein the soybean processed food is comprised of at least one of soybean flour, soybean protein, soybean tofu, soybean milk, soybean sauce, soybean oil, black bean flour, black bean protein, black bean tofu, black bean milk, black bean sauce, and black bean oil.

7. The soybean beverage composition according to claim 1, wherein the vinegar blend is comprised of at least one of pineapple vinegar, apple vinegar, lemon vinegar, orange vinegar, grape vinegar, blueberry vinegar, raspberry vinegar, kiwi vinegar, strawberry vinegar, cranberry vinegar, cherry vinegar and prune vinegar.

8. A method of preparing a soybean beverage composition, comprising:
providing a soybean processed food;
providing water;
providing a vinegar blend;
providing at least one first juice selected from the group consisting of fruit juice;
providing at least one second juice selected from the group consisting of vegetable juice; and
combining the soybean processed food, water, the at least one first juice, the at least one second juice; and the vinegar blend into a mixture.

9. The method of claim 8, wherein the providing at least one first juice comprises providing fruit juice.

10. The method of claim 9, wherein the providing comprises providing at least one of apple juice, banana juice, blueberry juice, cantaloupe juice, cherry juice, cranberry juice, grape juice, grapefruit juice, kiwi fruit juice, orange juice, pear juice, pineapple juice, prune juice, berry juice, raspberry juice, and strawberry juice.

11. The method of claim 8, wherein the providing at least one second juice comprises providing vegetable juice.

12. The method of claim 11, wherein the providing comprises providing at least one of carrot juice, celery juice, green barley juice, green lettuce juice, kale juice, parsley juice, spinach juice, and tomato juice.

13. The method of claim 8, wherein the providing a soybean processed food comprises providing at least one of soybean flour, soybean protein, soybean tofu, soybean milk, soybean sauce, soybean oil, black bean flour, black bean protein, black bean tofu, black bean milk, black bean sauce, and black bean oil.

14. The method of claim 8, wherein the providing a vinegar blend comprises providing at least one of pineapple vinegar, apple vinegar, lemon vinegar, orange vinegar, grape vinegar, blueberry vinegar, raspberry vinegar, kiwi vinegar, strawberry vinegar, cranberry vinegar, cherry vinegar, and prune vinegar.

15. A method of preparing a soybean beverage composition, comprising:
grinding a soybean processed food;
providing water;
providing a vinegar blend;
providing at least one first juice selected from the group consisting of fruit juice;
providing at least one second juice selected from the group consisting of vegetable juice; and
mixing the ground soybean processed food, water, the vinegar blend, the at least one first juice, and the at least one second juice to form a liquid mixture; and bottling the liquid mixture.

16. The method of claim 15, wherein the providing at least one first juice comprises providing fruit juice.

17. The method of claim 16, wherein the providing comprises providing at least one of apple juice, banana juice, blueberry juice, cantaloupe juice, cherry juice, cranberry juice, grape juice, grapefruit juice, kiwi fruit juice, orange juice, pear juice, pineapple juice, prune juice, berry juice, raspberry juice, and strawberry juice.

18. The method of claim 15, wherein the providing at least one second juice comprises providing at least one of carrot juice, celery juice, green barley juice, green lettuce juice, kale juice, parsley juice, spinach juice, and tomato juice.

19. The method of claim 15, wherein the grinding a soybean processed food comprises grinding at least one of soybean flour, soybean protein, soybean tofu, soybean milk, soybean sauce, soybean oil, black bean flour, black bean protein, black bean tofu, black bean milk, black bean sauce, and black bean oil.

20. The method of claim 15, wherein the providing a vinegar blend comprises providing at least one of pineapple vinegar, apple vinegar, lemon vinegar, orange vinegar, grape vinegar, blueberry vinegar, raspberry vinegar, kiwi vinegar, strawberry vinegar, cranberry vinegar, cherry vinegar, and prune vinegar.
